(19) United States
(12) Patent Application Publication
(10) Pub. No.: US 2015/0018023 A1
(43) Pub. Date: Jan. 15, 2015

(54) ELECTRONIC DEVICE

(71) Applicant: NIKON CORPORATION, Tokyo (JP)

(72) Inventors: Hiromi Tomii, Yokohama-shi (JP); Sayako Yamamoto, Kawasaki-shi (JP); Mitsuko Matsumura, Sagamihara-shi (JP); Saeko Samejima, Tokyo (JP); Yae Nakamura, Kawasaki-shi (JP); Masakazu Sekiguchi, Kawasaki-shi (JP)

(21) Appl. No.: 14/381,030

(22) PCT Filed: Nov. 2, 2012
(86) PCT No.: PCT/JP2012/078501

§ 371 Date: Aug. 26, 2014

(30) Foreign Application Priority Data
Mar. 1, 2012 (JP) 2012-045847
Mar. 1, 2012 (JP) 2012-045848

(51) Int. Cl. H04W 4/12; H04L 12/58; H04W 88/02

(52) U.S. Cl. CPC H04W 4/12; H04W 88/02; H04L 51/04
USPC 455/466

(57) ABSTRACT

To acquire information related to contents of word-of-mouth information, an electronic device includes: an input unit that accepts an input of a text from a user; an information acquiring unit that acquires information of the user in relation to the input of the text when allowed to acquire the information by the user; and a transmitting unit that transmits the text and the information of the user.

### TECHNICAL FIELD

The present invention relates to electronic devices.

### BACKGROUND ART

Word-of-mouth information spreading users' voices and evaluations on various matters on the Internet has been used. Meanwhile, a word-of-mouth information determining device that determines whether a text input by a user is word-of-mouth information has been suggested (see Patent Document 1, for example).

### PRIOR ART DOCUMENTS

### Patent Documents

Patent Document 1: Japanese Patent Application Publication No. 2006-244305

### SUMMARY OF THE INVENTION

### Problems to be Solved by the Invention

However, the conventional word-of-mouth information determining device simply determines whether a text input by a user is word-of-mouth information, and cannot acquire information (such as word-of-mouth information credibility and reliability) related to the contents of the word-of-mouth information.

The present invention has been made in view of the above problems, and aims to provide an electronic device that is capable of acquiring information related to the contents of word-of-mouth information.

### Means for Solving the Problems

An electronic device of the present invention has: an input unit configured to accept an input of a text from a user; an information acquiring unit configured to acquire information relating to the user in association with the input of the text when allowed to acquire the information by the user; and a transmitting unit configured to transmit the text and the information of about the user.

In this case, the information acquiring unit may acquire information to be used for estimating an emotion of the user. The information acquiring unit may include a biological sensor configured to acquire biological information of the user. The information acquiring unit may include a force sensor configured to detect a force related to the input from the user. The information acquiring unit may include an imaging unit configured to capture an image of the user in relation to the input of the text. The information acquiring unit may include an environment sensor configured to acquire information relating to an environment of the user in relation to the input of the text.

Further, in the electronic device of the present invention, the transmitting unit may transmit image data together with the text and the information of the user. The transmitting unit may transmit metadata accompanying the image data when allowed to transmit the metadata by the user. The transmitting unit may be configured so as not to transmit metadata accompanying the image data when not allowed to transmit the metadata by the user.

Further, the electronic device of the present invention may have a detecting unit configured to detect the metadata. The detecting unit may conduct the detection when allowed to detect the metadata by the user. The electronic device of the present invention may further have a weighting unit configured to extract text information corresponding to the information of the user from the text, and perform weighting on the text based on a result of a comparison between the information of the user and the corresponding text information.

An electronic device of the present invention has: an input unit configured to accept an input from a user; and a biological information acquiring unit configured to acquire biological information of the user in relation to the input when allowed to acquire the biological information by the user.

An electronic device of the present invention has: an input unit configured to input a text and information of a user in the middle of creating the text; and an extracting unit configured to extract information related to one of the text and the information of the user from the other one of the text and the information of the user.

In this case, the electronic device of the present invention may further have a weighting unit configured to perform weighting on the text based on the information extracted by the extracting unit. In this case, the weighting unit may perform the weighting on the text based on a result of a comparison between the information of the user and the text corresponding to the information of the user. There may be provided a notifying unit configured to make a notification concerning the text based on a result of the weighting. The extracting unit may extract information relating to an emotion of the user. The extracting unit may extract information relating to an environment of the user. The extracting unit may extract information relating to at least one of a location and a date.

The electronic device may further have: an image input unit configured to input image data and metadata accompanying the image data; and a comparing unit configured to compare at least one of the text and the information of the user with the metadata. In this case, there may be provided with a weighting unit configured to perform weighting on the text based on a result of the comparison performed by the comparing unit.

The electronic device of the present invention may further have: an acquiring unit configured to acquire information of a person wishing to view the text; a detecting unit configured to detect information of the user, the information of the user being similar to the information of the person wishing to view the text; and a providing unit configured to provide the text based on the information of the user detected by the detecting unit.

When the electronic device of the present invention is equipped with the weighting unit, the electronic device may be configured so that when the text includes text information about a location, and a difference between the text information about the location and a place of input of the text is small, the weighting unit sets a high weight. When the text includes text information of a date, and a difference between the text information of the date and a date of input of the text is small, the weighting unit may set a high weight. When the text includes text information about an evaluation of an object, and a difference between a date of input of the text and a date of acquisition of the object is large, the weighting unit may set a high weight. The electronic device may be configured so that the higher the weight is, the more credible the text is.

### Effects of the Invention

An electronic device of the present invention can achieve an effect to acquire information related to the contents of word-of-mouth information.

### BRIEF DESCRIPTION OF DRAWINGS

FIG. 1 is a diagram schematically illustrating the configuration of an information processing system according to an exemplary embodiment;

FIG. 2A is a diagram illustrating a mobile terminal seen from the front side (the −Y-side), and FIG. 2B is a diagram illustrating the mobile terminal seen from the back side (the +Y-side);

FIG. 3 is a block diagram of a mobile terminal;

FIG. 4 is a diagram showing an example of an image data table;

FIG. 5 is a diagram showing an example of a user information table;

FIG. 6 is a block diagram of a server;

FIG. 7 is a diagram showing an example of a text information table;

FIG. 8 is a flowchart showing a process to be performed by the control unit of a mobile terminal in relation to a word-of-mouth information input;

FIG. 9 is a flowchart showing a weighting process to be performed by the server in relation to credibility of word-of-mouth information;

FIG. 10 is a diagram showing an example of a location information comparison table;

FIG. 11 is a diagram showing an example of a weighting information table; and

FIG. 12A is a diagram showing an example of a time information comparison table of an experience type, and FIG. 12B is a diagram showing an example of a time information comparison table of a purchase type.

### MODES FOR CARRYING OUT THE INVENTION

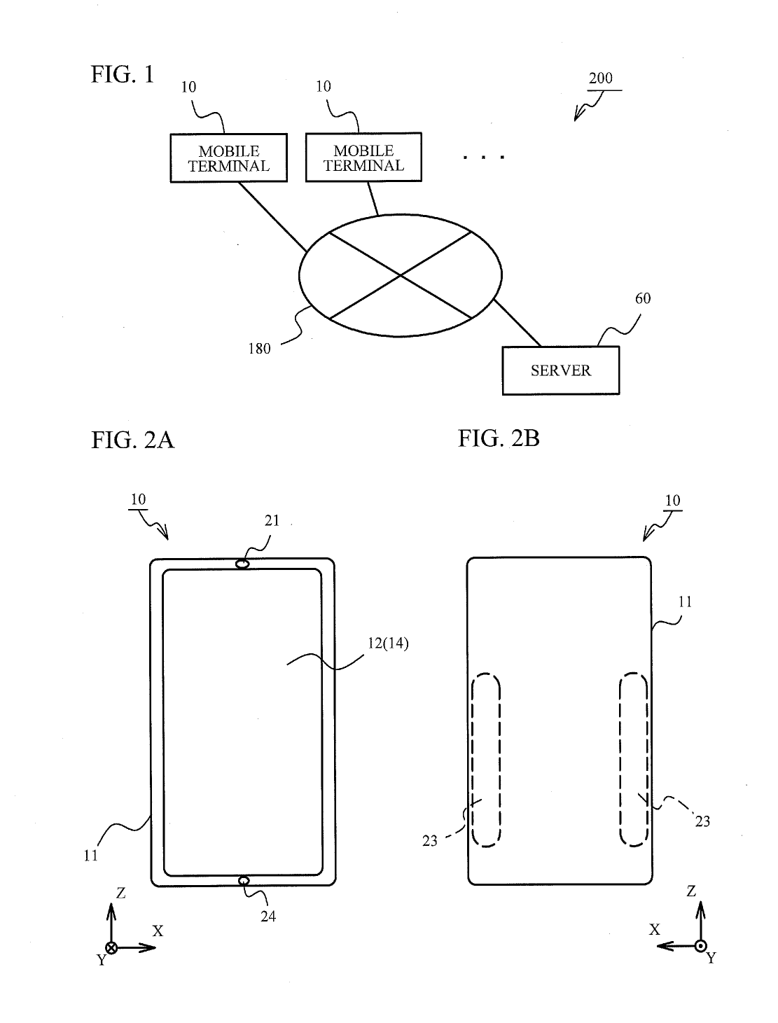

The following is a detailed description of an information processing system according to an exemplary embodiment, with reference to FIGS. 1 through 12. The information processing system of this embodiment is a system that determines credibility of word-of-mouth information that is input mostly by users.

FIG. 1 schematically illustrates the structure of an information processing system 200 of this embodiment. The information processing system 200 includes mobile terminals 10 and a server 60. The mobile terminals 10 and the server 60 are connected to a network 180 such as the Internet.

The mobile terminals 10 is information devices that are used while being carried by users. The mobile terminals 10 may be portable telephone devices, smartphones, PHSs (Personal Handy-phone Systems), PDA (Personal Digital Assistants), or the like, but are smartphones in this embodiment. The mobile terminals 10 each have a communication function such as a telephone function and a function for connecting to the Internet or the like, a data processing function for executing a program, and the like.

FIG. 2A is a diagram showing a mobile terminal 10, seen from the front side (the −Y-side). FIG. 2B is a diagram showing the mobile terminal 10, seen from the back side (the +Y-side). As shown in these drawings, the mobile terminal 10 has a thin plate-like form having a rectangular principal surface (the −Y-side surface), and has such a size as to be held with one hand.

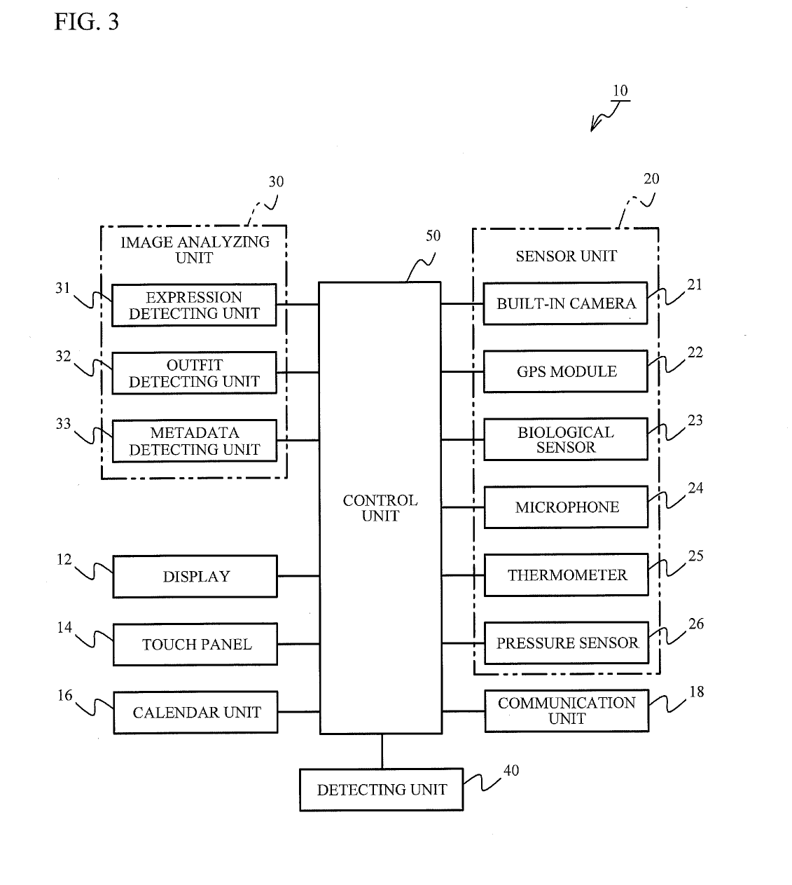

FIG. 3 is a block diagram of a mobile terminal 10. As illustrated in FIG. 3, the mobile terminal 10 includes a display 12, a touch panel 14, a calendar unit 16, a communication unit 18, a sensor unit 20, an image analyzing unit 30, a storage unit 40, and a control unit 50.

As illustrated in FIG. 2A, the display 12 is located on the side of the principal surface (the surface on the −Y-side) of the main frame 11 of the mobile terminal 10. The display 12 accounts for most area (90%, for example) of the principal surface of the main frame 11, for example. The display 12 displays an image and an image for operation inputs such as various kinds of information and buttons. The display 12 may be a device using a liquid crystal display element, for example.

The touch panel 14 is an interface that can input information to the control unit 50 in accordance with the user touching the touch panel 14. As shown in FIG. 2A, the touch panel 14 is incorporated into the surface of the display 12 or into the display 12. Accordingly, the user can intuitively input various kinds of information by touching the surface of the display 12.

The calendar unit 16 acquires time information that is stored in advance, such as time, day, month, and year, and outputs the time information to the control unit 50. The calendar unit 16 has a timer function. In this embodiment, the calendar unit 16 detects the time of creation of word-of-mouth information or the time contained in the metadata of an image accompanying the word-of-mouth information.

The communication unit 18 communicates with the server 60 and other mobile terminals on the network 180. The communication unit 18 has a wireless communication unit that accesses a wide area network such as the Internet, a Bluetooth (a registered trade name) unit that realizes communications by Bluetooth (a registered trade name), a Felica (a registered trade name) chip, and the like, and communicates with the server and other mobile terminals.

The sensor unit 20 includes various sensors. In this embodiment, the sensor unit 20 includes a built-in camera 21, a GPS (Global Positioning System) module 22, a biological sensor 23, a microphone 24, a thermometer 25, and a pressure sensor 26.

The built-in camera 21 is a non-contact sensor that has an imaging lens (such as a wide-angle lens) and an imaging device, captures a still image or a moving image of an object, and detects a facial expression of the user in a con-contact manner in cooperation with the later described image analyzing unit 30. The imaging device is a CCD or a CMOS device, for example. The imaging device includes a color filter formed with the three primary colors of R, G, and B arranged in the Bayer array, and outputs color signals corresponding to the respective colors, for example. The built-in camera 21 is located on the surface (the principal surface (the surface on the −Y-side)) on which the display 12 is placed in the main frame 11 of the mobile terminal 10. Accordingly, the built-in camera 21 can capture an image of the face or the outfit of the user who is operating the touch panel 14 of the mobile terminal 10. While an image of the object is being captured with the camera, the control unit 50 creates metadata (EXIF data) about the image captured with the camera. The metadata about the captured image contains imaging date, imaging location (GPS information), resolution, focal distance, and the like. The imaging date is detected by the above described calendar unit 16, and the imaging location is detected by the later described GPS module 22. In this embodiment, a facial expression of the user is captured with the built-in camera 21 while the user is creating word-of-mouth information. Also, the user uses the built-in camera 21 to capture an image to be attached to the word-of-mouth information.

The GPS module 22 is a sensor that detects the location (the latitude and longitude, for example) of the mobile terminal 10. In this embodiment, the GPS module 22 acquires (detects) information (user information) about the location of the user, while the user is creating word-of-mouth information.

As shown in FIG. 2B, the biological sensor 23 is attached to the back surface of the main frame 11 of the mobile terminal 10, for example. However, the location of the biological sensor 23 is not limited to the above, and the biological sensor 23 may be attached to the front surface of the main frame 11 or may be placed at two locations in the side portions of the long sides. The biological sensor 23 is a sensor that acquires the states of the user holding the mobile terminal 10. The biological sensor 23 acquires the states of the user, such as the body temperature, the blood pressure, the pulse, the amount of perspiration, and the grip strength of the user. For example, the biological sensor 23 includes a sensor that acquires information about the grip of the user holding the mobile terminal 10 (such as grip strength). With this sensor, the user's holding of the mobile terminal 10 and the intensity of force of the user holding the mobile terminal 10 can be detected. The later described control unit 50 may start acquiring information from another biological sensor when this sensor detects the user's holding of the mobile terminal 10. Where the power supply is on, the control unit 50 may also perform control to switch on the other functions (or return from a sleep state) when this sensor detects the user's holding of the mobile terminal 10.

The biological sensor 23 further includes a body temperature sensor that measures body temperature, a blood pressure sensor that detects blood pressure, a pulse sensor that detects a pulse, and a perspiration sensor that measures an amount of perspiration (any of which is not shown in the drawings). The pulse sensor may be a sensor that detects a pulse by emitting light to the user from a light emitting diode and receiving the light reflected from the user in response to the light emission as disclosed in Japanese Patent Application Publication No. 2001-276012 (U.S. Pat. No. 6,526,315), or may be a watch-type biological sensor as disclosed in Japanese Patent Application Publication No. 2007-215749 (US 2007/0191718 A), for example.

When the user is excited, gets angry, or gets sad, there are normally changes in the grip strength of the user holding the mobile terminal 10, and the body temperature, the blood pressure, and the pulse of the user. Accordingly, with the biological sensor 23, information (user information) that indicates the state of excitation and emotion such as joy, anger, pathos, or humor of the user can be obtained.

The microphone 24 is a sensor that inputs sound from the area surrounding the mobile terminal 10. The microphone 24 is located in the vicinity of the edge on the lower side (the −Z-side) of the principal surface (the surface on the −Y-side) of the main frame 11 of the mobile terminal 10, for example. That is, the microphone 24 is located in such a position as to face the mouth of the user (or in such a position as to readily collect speech voice of the user) when the user uses the telephone function. In this embodiment, the microphone 24 collects information (user information) about the words uttered by the user when he/she is creating (inputting) word-of-mouth information, and the sound from the area surrounding the user.

The thermometer 25 is a sensor that detects the temperature in the area surrounding the mobile terminal 10. The thermometer 25 may also share a function with the sensor in the biological sensor 23 that detects the body temperature of the user. In this embodiment, the thermometer 25 acquires temperature information (user information) about the temperature at the location where the user exists while the user is creating word-of-mouth information.

The pressure sensor 26 is a sensor that detects the pressure of a finger of the user (the intensity of force at the time of an input) when there is an input from the user using a software keyboard displayed on the display 12. The pressure sensor 26 may be a piezoelectric sensor including a piezoelectric element, for example. A piezoelectric sensor electrically detects vibration by converting an external force into a voltage by virtue of a piezoelectric effect. The pressure sensor 26 acquires information (user information) about the strength (the intensity of force) of an input when the user inputs word-of-mouth information. It is presumed that, when the user feels strongly about word-of-mouth information, the user naturally presses the keys hard while creating the word-of-mouth information. It can also be said that word-of-mouth information about which the writer has a strong feeling is highly credible.

The image analyzing unit 30 analyzes an image captured by the built-in camera 21 and an image (an accompanying image) the user has attached to word-of-mouth information. An accompanying image is not necessarily an image captured by the built-in camera 21. For example, an accompanying image may be an image captured by a different camera from the mobile terminal 10. In a case where an image captured by the built-in camera 21 of the mobile terminal 10 is used as an accompanying image, the accompanying image may be captured either before or during creation of word-of-mouth information. On the other hand, image data captured by a different camera form the mobile terminal 10 is stored in the storage unit 40 when word-of-mouth information is created.

As shown in FIG. 3, the image analyzing unit 30 includes an expression detecting unit 31, an outfit detecting unit 32, and a metadata detecting unit 33.

The expression detecting unit 31 compares face image data captured by the built-in camera 21 with the data registered in a facial expression DB stored in the storage unit 40, to detect a facial expression of the user. The facial expression DB stores image data of a smiling face, a crying face, an angry face, a surprised face, a frowning face with line between eyebrows, a nervous face, a relaxed face, and the like. In this embodiment, the facial expression of the user is captured by the built-in camera 21 when the user is creating word-of-mouth information. Accordingly, the expression detecting unit 31 can acquire data (user information) about the facial expression of the user by using the captured image.

An example method of detecting a smiling face is disclosed in US 2008-037841A. An example method of detecting lines between eyebrows is disclosed in US 2008-292148.

The outfit detecting unit 32 determines the type of outfit of the user captured by the built-in camera 21. The outfit detecting unit 32 detects an outfit by performing pattern matching between the image data of the outfit contained in the captured image and the image data stored in an outfit DB that is stored beforehand in the storage unit 40. The outfit DB stores image data for identifying outfits (suits, jackets, shirts, trousers, skirts, dresses, Japanese clothes, neckties, pocket handkerchiefs, coats, barrettes, glasses, hats, and the like). When the user purchases an item by using the communication unit 18 (or does shopping online or the like), the control unit 50 can store purchased item information (such as the color, shape, pattern, type, and other features of an outfit or the like) into the storage unit 40. In this case, the outfit detecting unit 32 may detect an outfit by comparing the image data of the outfit with the purchased item information (including an image). The outfit detecting unit 32 may also detect whether the user is heavily dressed (wearing a coat, for example) or whether the user is lightly dressed (wearing a short-sleeved shirt, for example).

In a case where the user attaches an image to word-of-mouth information, the metadata detecting unit 33 detects the metadata (EXIF data) accompanying the attached image.

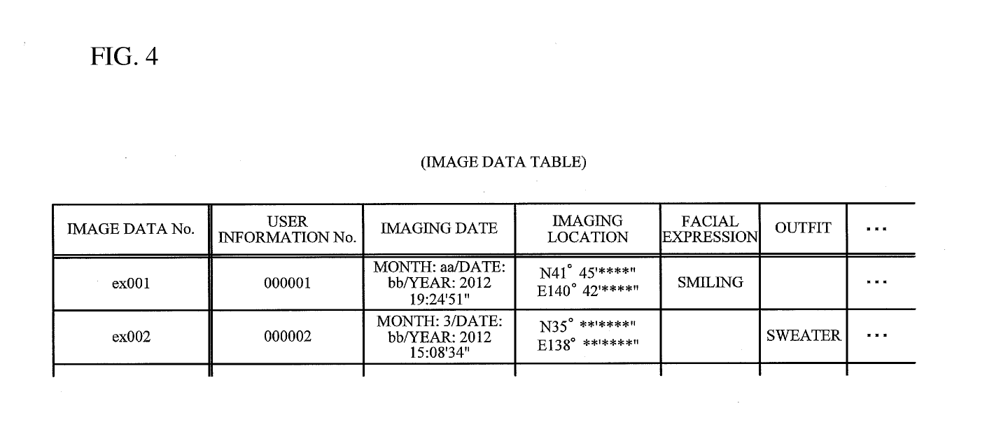

The information detected by the expression detecting unit 31, the outfit detecting unit 32, and the metadata detecting unit 33 is stored into the image data table shown in FIG. 4.

The image data table in FIG. 4 is a table that stores data about accompanying images, and includes the respective fields of image data Nos., user information Nos., imaging date, imaging locations, facial expressions, and outfits. In each image data No. field, the unique value for identifying metadata of an image is stored. In each user information No. field, the number for identifying user information that is acquired while word-of-mouth information accompanied by an image is being input is stored. In each imaging date field, the imaging date of an image is stored. In each imaging location field, the imaging location of an image is stored. In each imaging location field, the numerical values (the latitude and longitude) of location information may be stored, or the name of a location identified from location information based on map information stored in the storage unit 40 may be stored. In a case where an accompanying image has been captured at home, the latitude/longitude information may be allowed to have certain ranges so that the home will not be identified. Alternatively, the latitude/longitude information may be replaced simply with “home”, or any location information may not be disclosed. In this case, the user may be prompted to input whether the image has been captured at home, and the input may be displayed. In a case where an image accompanied by latitude/longitude information registered as “home” is attached to word-of-mouth information, the above mentioned display may be conducted. In each facial expression field, the facial expression of a person detected by the expression detecting unit 31 is stored. In each outfit field, the classification of the outfit of a person detected by the outfit detecting unit 32 is stored.

Referring back to FIG. 3, the storage unit 40 is a nonvolatile semiconductor memory (a flash memory), for example. The storage unit 40 stores a program to be executed by the control unit 50 to control the mobile terminal 10, various kinds of parameters for controlling the mobile terminal 10, user face information (image data), map information, the above described image data table, the later described user information table, and the like.

The storage unit 40 also stores the above mentioned facial expression DB and outfit DB, the mean values calculated from those data, information of the user (user information) detected by the sensor unit 20 while word-of-mouth information is being input, accompanying images captured by the built-in camera 21 or external cameras, and the like.

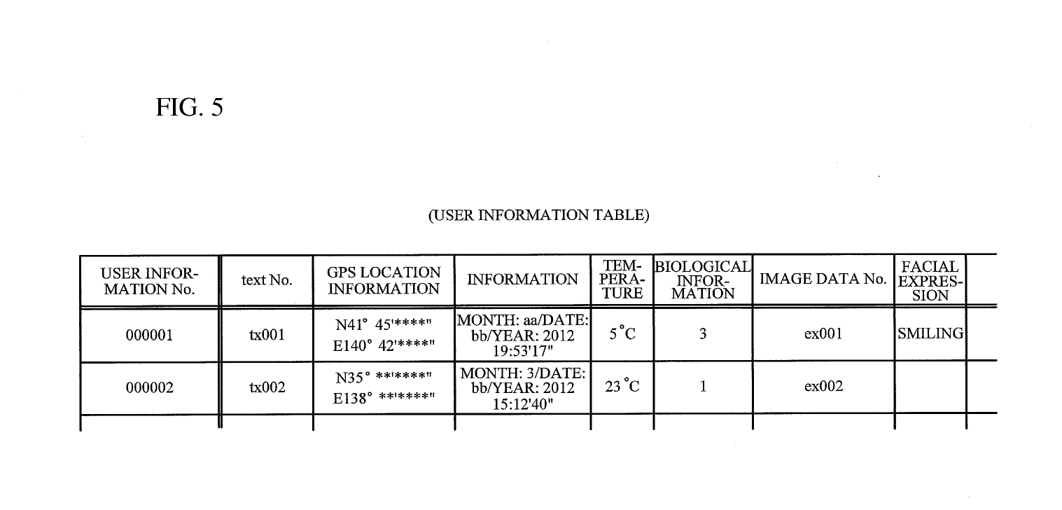

The control unit 50 includes a CPU, and controls all the processes to be performed by the mobile terminal 10. The control unit 50 also transmits word-of-mouth information created by the user, accompanying images, and the metadata of the accompanying images to the server 60, or transmits user information, which has been acquired while the user was creating word-of-mouth information, to the server 60. Here, the control unit 50 transmits the user information stored in the user information table shown in FIG. 5 to the server 60.

The user information table in FIG. 5 stores the user information that is acquired by the sensor unit 20 or the like while word-of-mouth information is being input. The time during which word-of-mouth information is being input may be part of the time required for inputting the word-of-mouth information, or may be the time from the input start to the input end. User information acquired before and after the input may also be included. Specifically, the user information table in FIG. 5 includes the respective fields of user information Nos., text Nos., GPS location information, creation dates, temperatures, biological information, image data Nos., and facial expressions.

In each user information No. field, the unique value for identifying user information is stored. The data in the image data table in FIG. 4 is associated with the data in the user information table by the user information Nos. and the image data Nos. In each text No. field, the number for identifying word-of-mouth information that has been input at the time of acquisition of user information is stored. In each GPS location information field, the location information acquired by the GPS module 22 about the user at the time of a word-of-mouth information input is stored. The data stored in the GPS location information is not necessarily the numerical values of location information as shown in FIG. 5, but may be the name of a location identified from the location information based on the map information in the storage unit 40. In a case where the user has inputted word-of-mouth information at home, the latitude/longitude information may be allowed to have certain ranges so that the home will not be identified. Alternatively, the latitude/longitude information may be replaced simply with “home”. In this case, the user may be prompted to input whether the word-of-mouth information has been input at home, and the above described storing may be conducted. In a case where word-of-mouth information has been input with latitude/longitude information registered beforehand as “home”, the above described storing may be conducted. In each creation date field, the date (obtained from the calendar unit 16) of a word-of-mouth information input is stored. In each temperature field, the temperature acquired by the thermometer 25 at the time of a word-of-mouth information input is stored. In each biological information field, a value obtained by quantifying the emotion and excitation of the user at the time of a word-of-mouth information input (or a value obtained by combining and quantifying outputs of the biological sensor 23, the microphone 24, and the pressure sensor 26) is stored. The numerical values may be on a scale of 1 to 3 (1 (smallest) to 3 (largest)) as shown in FIG. 5, or “medium”, “high”, and “very high” may be stored. In each image data No. field, the number for identifying the metadata of an image accompanying word-of-mouth information is stored. In a case where there are no accompanying images, the image data No. field is left blank. By the image data Nos., the data in the user information table in FIG. 5 is associated with the data in the image data table in FIG. 4. In each facial expression field, the facial expression of the user in the middle of inputting word-of-mouth information is stored. Alternatively, a moving image of the user may be captured during a word-of-mouth information input, the facial expression of the user may be detected by the expression detecting unit 31, and the facial expression captured when there is a large change therein may be recorded in a facial expression field. The average facial expression of the user during a word-of-mouth information input may be detected by the expression detecting unit 31, and then be recorded.

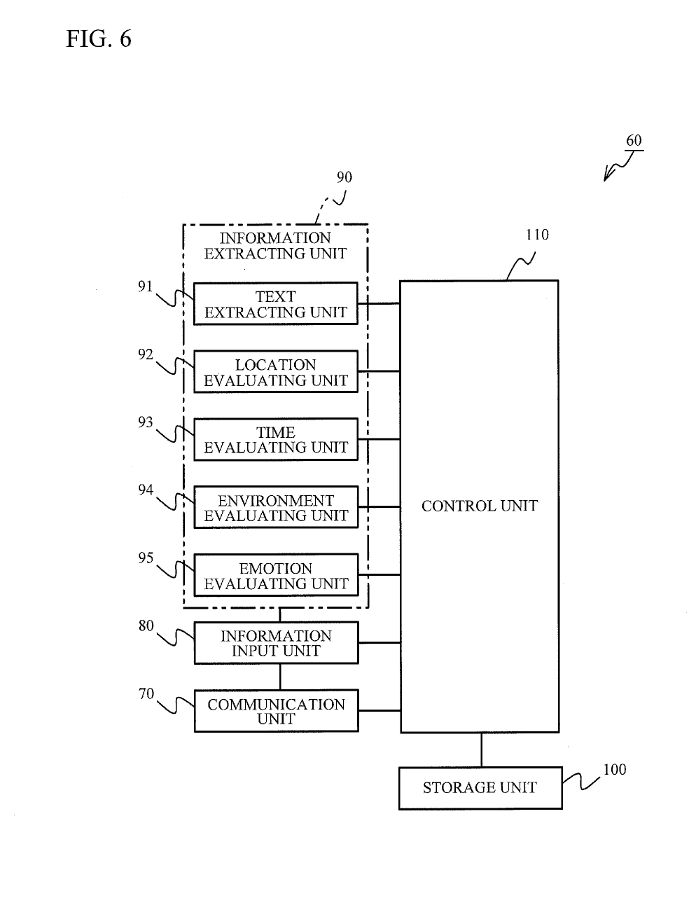

FIG. 6 is a block diagram of the server 60. Referring to FIG. 6, the server 60 is described below in detail.

As shown in FIG. 6, the server 60 includes a communication unit 70, an information input unit 80, an information extracting unit 90, a storage unit 100, and a control unit 110.

The communication unit 70 communicates with the communication units 18 of mobile terminals 10, and includes a wireless communication unit that accesses a wide area network such as the Internet, a Bluetooth (a registered trade name) unit that realizes communications by Bluetooth (a registered trade name), a Felica (a registered trade name) chip, and the like.

The information input unit 80 acquires word-of-mouth information created by users with mobile terminals 10 via the communication unit 70, and inputs the word-of-mouth information to the control unit 110 and the information extracting unit 90. A document created by a user accessing a word-of-mouth input screen of a website being managed by the server 60 from a mobile terminal 10 is word-of-mouth information. A check may be made to determine whether information created with each individual mobile terminal 10 is word-of-mouth information. A method disclosed in Japanese Patent Application Publication No. 2006-244305 may be used as a method of determining whether subject information is word-of-mouth information.

The information extracting unit 90 compares a specific text (such as a text indicating a location, a time, an environment, and the like) included in word-of-mouth information acquired from the information input unit 80 with user information indicating the states of the user, and performs weighting on the word-of-mouth information based on a result of the comparison. Specifically, the information extracting unit 90 includes a text extracting unit 91, a location evaluating unit 92, a time evaluating unit 93, an environment evaluating unit 94, and an emotion evaluating unit 95.

The text extracting unit 91 extracts specific texts (such as texts indicating a location, a time, an environment, and the like) included in word-of-mouth information by referring to a dictionary DB. The dictionary DB is stored in the storage unit 100. For example, the dictionary DB stores the names of places, architectures, and the like, such as “Mt. Hakodate”, “Tokyo Tower”, and “Yokohama Station”, as texts indicating locations. The dictionary DB also stores “morning”, “daytime”, “nighttime”, “sunup”, “sundown”, “noontime”, “spring”, “summer”, “autumn”, “winter”, and the like, as texts indicating times. The dictionary DB also stores texts indicating degrees of temperature and sound such as “hot”, “cold”, “quiet”, and “noisy”, as texts indicating environments. For example, the information input unit 80 inputs word-of-mouth information that reads, “The night view from Mt. Hakodate is beautiful, but the wind blowing from the north is cold”. In this case, the text extracting unit 91 refers to the dictionary DB, and extracts “Mt. Hakodate” as text information about a location (the name of a place), “nighttime” as text information about a time, and “cold” as text information relating to an environment.

The text extracting unit 91 determines whether word-of-mouth information is of an experience type or is of a purchase type. During the determination, the text extracting unit 91 refers to a classification dictionary DB (stored in the storage unit 100) for classifying information into experience types and purchase types.

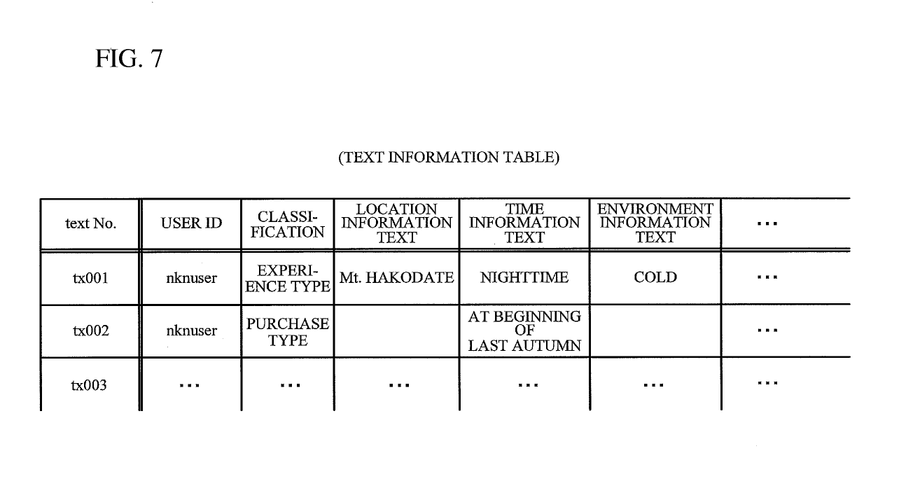

The text information that is included in word-of-mouth information and is extracted by the text extracting unit 91 is stored into the text information table shown in FIG. 7. The text information table shown in FIG. 7 includes the respective fields of text Nos., user IDs, classifications, location information texts, time information texts, and environment information texts.

In each text No. field, the unique value for identifying word-of-mouth information is stored. The data in the text information table in FIG. 7 is associated with the data in the user information table in FIG. 6 by the text Nos. In each user ID field, the ID of the user who has inputted the word-of-mouth information is stored. In each classification field, the type (an experience type or a purchase type) of the word-of-mouth information determined by the text extracting unit 91 is stored. In the respective fields of location information texts, time information texts, and environment information texts, the texts (texts indicating locations, times, environments, and the like) extracted from word-of-mouth information are stored. In each field of location information texts, time information texts, and environment information texts, one or more texts can be stored.

Referring back to FIG. 6, the location evaluating unit 92 compares the text information “Mt. Hakodate” extracted by the text extracting unit 91 with the information that has been output from the GPS module 22 of the mobile terminal 10 and has been input by the information input unit 80, and performs weighting in relation to the credibility of the word-of-mouth information. At the time of the comparison, the location evaluating unit 92 refers to a map DB (stored in the storage unit 100) that associates the names of places such as “Mt. Hakodate” with locations (latitudes and longitudes).

The time evaluating unit 93 compares the text information “nighttime” extracted by the text extracting unit 91 with the information that has been output from the calendar unit 16 of the mobile terminal 10 and has been input by the information input unit 80, and performs weighting in relation to the credibility of the word-of-mouth information. Based on the information stored in the classification field, the time evaluating unit 93 determines whether the word-of-mouth from the user is about an experience or is about a purchase, and performs weighting.

The environment evaluating unit 94 compares the text information “cold” extracted by the text extracting unit 91 with a result of detection that has been conducted by the thermometer 25 of the mobile terminal 10 and has been input by the information input unit 80, and performs weighting on the credibility of the word-of-mouth information. The environment evaluating unit 94 may acquire, via the communication unit 70, information about the outfit (information about whether the user is heavily dressed or is lightly dressed, for example) detected by the outfit detecting unit 32 of the mobile terminal 10, and perform weighting in relation to the credibility of the word-of-mouth information based on the information about the outfit. Alternatively, the environment evaluating unit 94 may perform weighting in relation to the credibility of the word-of-mouth information based on the existence/non-existence of an accompanying image.

The emotion evaluating unit 95 evaluates the emotion (joy, anger, pathos, or humor) of the user based on the outputs of the image analyzing unit 30, the biological sensor 23, the microphone 24, and the pressure sensor 26 of the mobile terminal 10, which have been input by the information input unit 80, and then performs weighting in relation to the credibility of the word-of-mouth information.

A specific method of weighting to be performed by the location evaluating unit 92, the time evaluating unit 93, the environment evaluating unit 94, and the emotion evaluating unit 95 in relation to the credibility of word-of-mouth information will be described later.

The information extracting unit 90 having the above described structure outputs a result of weighting performed in relation to the credibility of word-of-mouth information by the location evaluating unit 92, the time evaluating unit 93, the environment evaluating unit 94, and the emotion evaluating unit 95, to the control unit 110.

The storage unit 100 is a nonvolatile memory (a flash memory) or the like, and contains the map DB, the dictionary DB, and the classification DB for determining whether a user's word-of-mouth information is of an experience type or is of a purchase type. The storage unit 100 also associates word-of-mouth information input by the information input unit 80 with weighting information about the credibility of the word-of-mouth information determined by the information extracting unit 90, and stores the word-of-mouth information and the weighting information.

The control unit 110 includes a CPU, and controls the entire server 60. In this embodiment, the control unit 110 stores word-of-mouth information that is input by the information input unit 80 and weighting information into the storage unit 100. When there is a request for viewing of word-of-mouth information from a person who wishes viewing (a user using a mobile terminal or a personal computer connected to the network 180), the control unit 110 provides the word-of-mouth information. In this case, the control unit 110 may provide the credibility weighting information as well as the word-of-mouth information in response to all viewing requests, or may provide the credibility weighting information as well as the word-of-mouth information only in response to viewing requests from dues-paying members.

Processes to be performed in the information processing system 200 having the above described structure will be described below in detail.

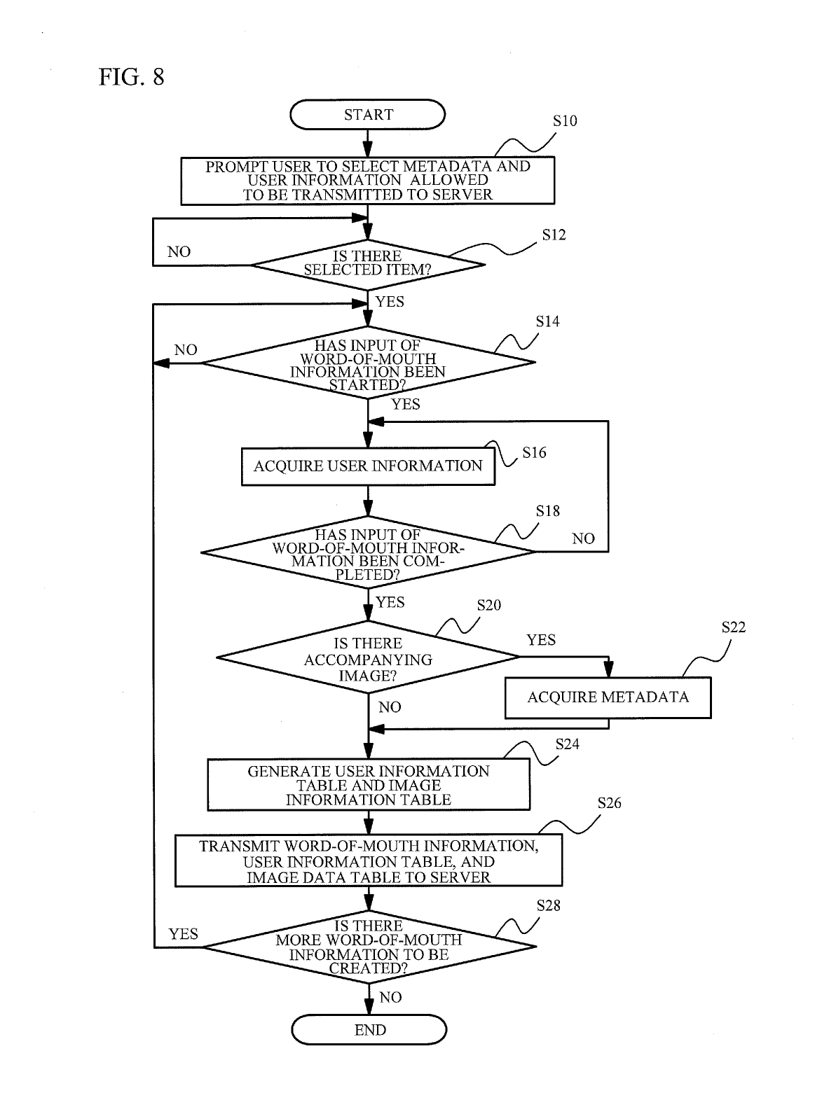

FIG. 8 is a flowchart showing a process to be performed by the control unit 50 of a mobile terminal 10 for a word-of-mouth information input. The process shown in FIG. 8 is started when a user accesses the word-of-mouth input screen of a website being managed by the server 60.

In step S10 of the process shown in FIG. 8, the control unit 50 causes the display 12 to display a screen to prompt the user to select metadata and user information that may be transmitted to the server 60 when the user posts word-of-mouth information.

In step S12, the control unit 50 stands by until the user selects items that may be transmitted to the server 60 from among the items displayed on the display 12. In this case, the control unit 50 moves on to step S14 when the user performs selection. The description below is based on an assumption that the user selects all the items of metadata and user information (that may be transmitted to the server 60).

After moving on to step S14, the control unit 50 stands by until the user starts inputting word-of-mouth information. In this case, the control unit 50 moves on to step S16 when the user starts inputting word-of-mouth information.

After moving on to step S16, the control unit 50 acquires user information by using the sensor unit 20. In this case, the control unit 50 acquires the user information selected in step S12. Specifically, the control unit 50 acquires the items selected by the user from among images of the user and the surroundings of the user, the location of the user, the biological information of the user, voice of the user and sound from the surroundings of the user, the temperature at the place where the user exists, the force of the user pressing the touch panel 14, and the like. In a case where the user information includes an item that is not allowed to be transmitted to the server 60, the control unit 50 does not acquire information about the item.

In step S18, the control unit 50 determines whether the word-of-mouth information input by the user has been completed. In this case, the result of the determination in step S18 becomes affirmative when the user presses the submit button to transmit word-of-mouth information to the server 60, for example. In a case where the result of the determination in step S18 is affirmative, the control unit 50 moves on to step S20. In a case where the result of the determination is negative, the procedure and determination of steps S16 and S18 are repeated.

After moving on to step S20 as the result of the determination in step S18 becomes affirmative, the control unit 50 determines whether the word-of-mouth information is accompanied by an image. In a case where the result of this determination is affirmative or where the word-of-mouth information is accompanied by an image, the control unit 50 moves on to step S22. In a case where the result of the determination is negative, on the other hand, the control unit 50 moves on to step S24. However, if the user does not wish transmission of metadata about the accompanying image to the server 60 in step S12, the control unit 50 moves on to step S24. At this point, the metadata (information about the imaging date and the imaging location) of the accompanying image may be deleted, or may be temporarily masked so that transmission of the metadata not to be transmitted to the server 60 is prevented.

After moving on to step S22, the control unit 50 acquires the metadata of the accompanying image. The control unit 50 then moves on to step S24.

After moving on to step S24, the control unit 50 generates the user information table (FIG. 5) and the image data table (FIG. 4) by using the user information and the metadata acquired in steps S14 and S22. In this case, the control unit 50 inputs the acquired user information directly to the tables. The control unit 50 also inputs, to the respective tables, results of an analysis carried out on the state of the user at the time of creation of the word-of-mouth information based on a result of facial expression detection conducted by the expression detecting unit 31, results of inputs to the biological sensor 23 and the microphone 24, and an output from the pressure sensor 26. In a case where there is an accompanying image, and the face of the user is recognized by the image analyzing unit 30, the emotion of the user may be estimated by detecting the facial expression of the user in the accompanying image with the expression detecting unit 31. In a case where the metadata of the accompanying image includes biological information of the user, the control unit 50 may estimate the emotion of the user by taking into account the user biological information included in the metadata of the accompanying image. In a case where the state of the user at the time of creation of the word-of-mouth information is substantially the same as the state of the user based on the analysis of the accompanying image, either one set of the data should be used.

In step S26, the control unit 50 transmits the word-of-mouth information, the user information table, and the image data table to the server 60 via the communication unit 18.

In step S28, the control unit 50 determines whether the user further creates word-of-mouth information. In a case where the result of this determination is affirmative, the control unit 50 returns to step S14, and the procedures of step S14 and thereafter are carried out in the same manner as above. In a case where the result of the determination in step S28 is negative, the control unit 50 ends the process shown in FIG. 8.

As described above, by carrying out the process shown in FIG. 8, word-of-mouth information that has been input by a user, and a user information table containing the information of the user in the middle of inputting the word-of-mouth information can be transmitted to the server 60. In a case where the word-of-mouth information is accompanied by an image, the image and an image data table containing the metadata of the image can be transmitted to the server 60. Of the user information and the metadata, items allowed to be transmitted by the user are transmitted to the server 60, but items not allowed to be transmitted by the user are not transmitted to the server 60.

Although the user information to be transmitted to the server is selected in step S10 in the flowchart shown in FIG. 8, necessary information may be acquired based on text information extracted by the text extracting unit 91. In this case, the information of the user in the middle of inputting the word-of-mouth information is stored into the storage unit 40, and the information of the user in the middle of inputting the word-of-mouth information may be later obtained from the storage unit 40. Alternatively, the user information of the user (within several minutes) after the input of the word-of-mouth information may be acquired. Therefore, in step S26, the word-of-mouth information, the user information, and the image data may not be transmitted to the server 60 at the same time, but may be transmitted at different appropriate times.

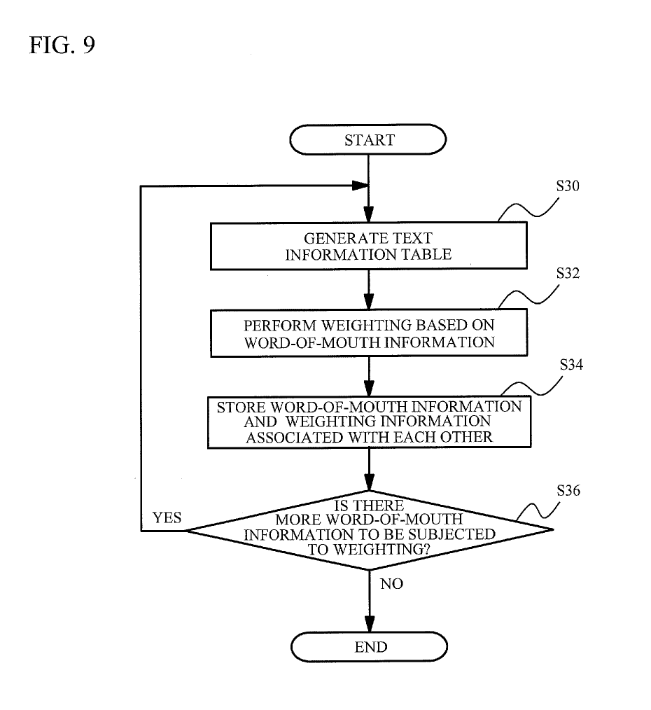

Referring now to the flowchart shown in FIG. 9, a weighting process to be performed by the server 60 in relation to the credibility of word-of-mouth information is described in detail. The process shown in FIG. 9 is started when the information input unit 80 inputs word-of-mouth information to the information extracting unit 90 and the control unit 110 via the communication unit 70.

In step S30 in the process shown in FIG. 9, the control unit 110 issues an instruction to the text extracting unit 91 to generate the text information table (FIG. 7) from word-of-mouth information acquired from a mobile terminal 10. In this case, the text extracting unit 91 extracts a location information text, a time information text, an environment information text, and the like from the word-of-mouth information, inputs those texts to the text information table, and determines the type of the word-of-mouth information. More specifically, the text extracting unit 91 determines whether the word-of-mouth information is of an experience type or is of a purchase type, by using the classification dictionary stored in the storage unit 100. The type of the word-of-mouth information is determined in this manner, because high weight needs to be added to word-of-mouth information created immediately after the experience in the case of an experience type, but low weight needs to be added to word-of-mouth information created immediately after the purchase in the case of a purchase type.

In a case where input word-of-mouth information (text) includes the name of a sightseeing area or a word for an experience such as “seeing”, “eating”, or “visiting”, which is not related to a purchase in accordance with the classification dictionary DB, the text extracting unit 91 determines that the word-of-mouth information is of an experience type. In a case where word-of-mouth information includes the name of a product, the name of a manufacturer, a word related to design, or a word related to a price in accordance with the classification dictionary DB, the text extracting unit 91 determines that the word-of-mouth information is of a purchase type. A word related to a price may be an actual number indicating a specific amount of money, or a word such as “expensive”, “inexpensive”, or “bargain”. In a case where a user can input the type of word-of-mouth information on the word-of-mouth input screen of the website being managed by the server 60, the text information table should be generated in accordance with the input.

In step S32, the control unit 110 issues an instruction to the information extracting unit 90 to perform weighting in relation to the credibility of the word-of-mouth information based on the word-of-mouth information (the text information table). A specific method of weighting in relation to the credibility of the word-of-mouth information will be described below in detail.

In the description below, a case where a user has input the word-of-mouth information of text No. tx001 in FIG. 7, which reads, “The night view from Mt. Hakodate is beautiful, but the wind blowing from the north is cold” is compared with a case where a user has input the word-of-mouth information of text No. tx002, which reads, “The red V-neck sweater I bought at the beginning of last autumn was a bargain”.

As shown in FIG. 7, from the word-of-mouth information of text No. tx001, “Mt. Hakodate” is extracted as the location information text, “nighttime” is extracted as the time information text, and “cold” is extracted as the environment information text. This word-of-mouth information is of an experience type. From the word-of-mouth information of text No. tx002, “at the beginning of last autumn” is extracted as the time information. This word-of-mouth information is of a purchase type. In FIG. 7, instead of “at the beginning of last autumn”, the two texts of “last autumn” and “at the beginning” may be input to the time information text.

The control unit 110 issues an instruction to the information extracting unit 90 to determine the weighting coefficients for the respective items of the location information texts, the time information text, and the environment information texts in the text information table.

(Location Information Text Weighting)

In the case of the word-of-mouth information of text No. tx001, the location evaluating unit 92 extracts the location information text “Mt. Hakodate” of the text information table. The location evaluating unit 92 also extracts GPS location information from the user information table. The location evaluating unit 92 then extracts the location (the latitude and longitude) indicated by the location information text “Mt. Hakodate” by referring to the map DB, and compares the location with the GPS location information. In this comparison, the location evaluating unit 92 calculates the distance between two points.

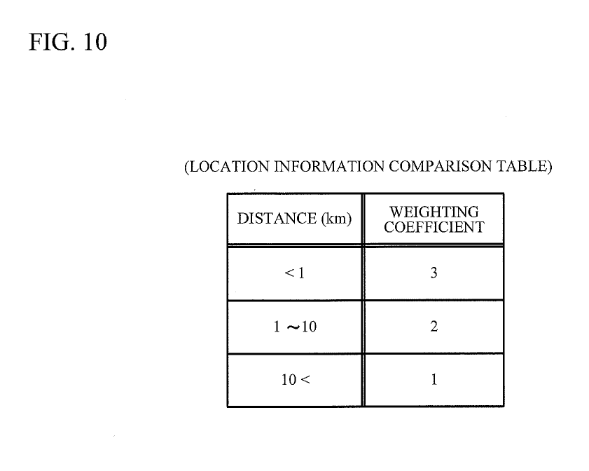

Using the distance between the two points calculated in the above manner and the location information comparison table shown in FIG. 10, the location evaluating unit 92 determines the weighting coefficient for the location information text. Specifically, the location evaluating unit 92 sets the weighting coefficient at 3 when the user is in Mt. Hakodate (where the distance between the two points is shorter than 1 km), sets the weighting coefficient at 2 when the user is in the vicinity of the Mt. Hakodate (where the distance between the two points is 1 to 10 km), and sets the weighting coefficient at 1 in any other cases (where the distance between the two points is longer than 10 km).

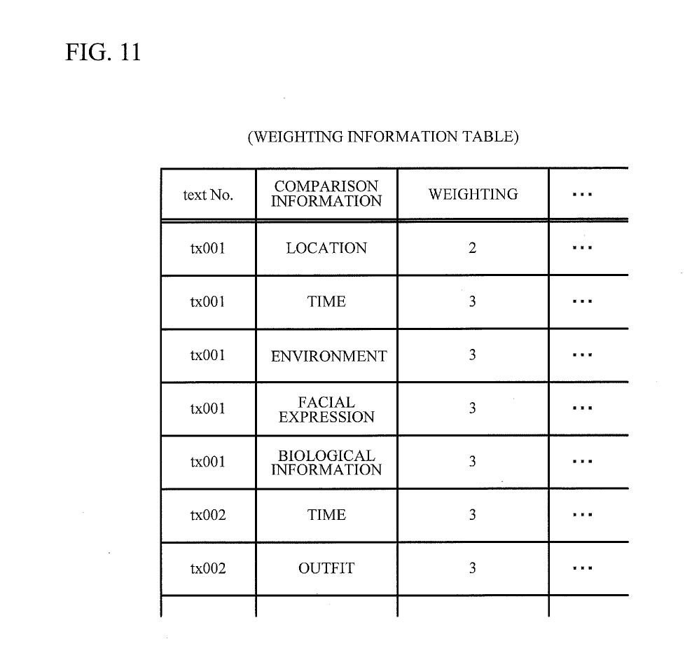

The data having the weighting coefficients determined are stored into the weighting coefficient storing table shown in FIG. 11. The table shown in FIG. 11 stores text Nos. of the word-of-mouth information for which the weighting coefficients have been calculated, comparison information, and the weighting coefficients. The result of the above described weighting of the location information text “Mt Hakodate” is stored in the first row in FIG. 11.

(Time Information Text Weighting)

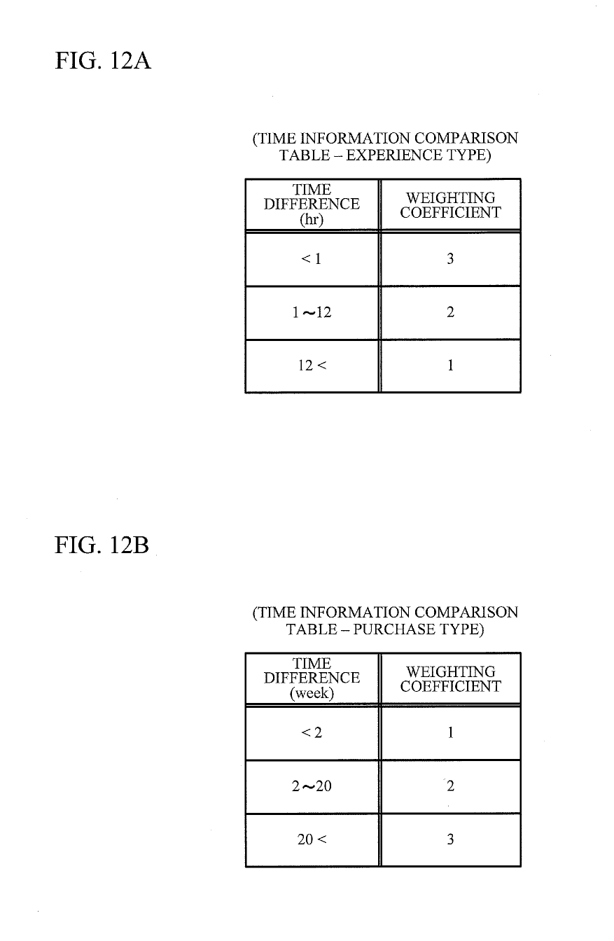

In the case of the word-of-mouth information of text No. tx001, the time evaluating unit 93 extracts the time information text “nighttime” of the text information table. In the case of the word-of-mouth information of text No. tx002, on the other hand, the time evaluating unit 93 extracts the time information text “at the beginning of last autumn” of the text information table. As the word-of-mouth information of text No. tx001 is of an experience type, the time evaluating unit 93 refers to the experience-type time information comparison table shown in FIG. 12A at the time of weighting. As the word-of-mouth information of text No. tx002 is of a purchase type, the time evaluating unit 93 refers to the purchase-type time information comparison table shown in FIG. 12B at the time of weighting. The experience-type time information comparison table shown in FIG. 12A is designed so that the weighting coefficient is greater immediately after an experience, because word-of-mouth information created immediately after an experience is more realistic than word-of-mouth information created a certain time after an experience. The purchase-type time information comparison table shown in FIG. 12B is designed so that the weighting coefficient is smaller immediately after a purchase, since a product tends to be highly evaluated immediately after the purchase due to the feeling of joy from the acquisition.

The time evaluating unit 93 extracts the text creating time of the word-of-mouth information from the creating time column in the user information table. The time evaluating unit 93 also determines an approximate time from the time information text, and obtains the difference (time difference) from the time of creation of the word-of-mouth information. The time evaluating unit 93 determines the appropriate time from the time information text by referring to the dictionary DB related to time information. In the dictionary DB, the text “nighttime” is associated with a time range from 18:00 to 3:00 next day, for example, and a representative value (22:00, for example).

For experience-type information like the word-of-mouth information of text No. tx001, the time evaluating unit 93 refers to FIG. 12A, to set the weighting coefficient at 3 if the word-of-mouth information is real-time information (created within one hour), set the weighting coefficient at 2 if the word-of-mouth information was created within half a day, and set the weighting coefficient at 1 in any other cases.

In a case where a time range is determined from a time information text like the text “nighttime”, and the creating time of the word-of-mouth information is included in the time range, the word-of-mouth information can be determined to be real-time information. The weighting coefficient determined in such a manner is stored into the weighting information table in FIG. 11 (see the second row in FIG. 11).

For purchase-type information like the word-of-mouth information of text No. tx002, on the other hand, the time evaluating unit 93 refers to FIG. 12B, to set the weighting coefficient at 1 if the word-of-mouth information was created within two weeks after the purchase, set the weighting coefficient at 2 if the word-of-mouth information was created more than two weeks after the purchase, and set the weighting coefficient at 3 if the word-of-mouth information was created more than 20 weeks (about five months) after the purchase. The weighting coefficient determined in this manner is stored into the weighting information table shown in FIG. 11 (the sixth row in FIG. 11). In the above description, the time evaluating unit 93 performs weighting in a case where the time information text “at the beginning of last autumn” is included in word-of-mouth information. However, the present invention is not limited to that. For example, in a case where a past Internet purchase is stored in the storage unit 40, for example, the weighting coefficient may be determined from the difference between the date of the purchase and the date of creation of the word-of-mouth information.

As described above, word-of-mouth information can be evaluated with high precision by changing methods to determine the weighting coefficient of a time information text (or changing time information comparison tables to be used) in accordance with the type (an experience type or a purchase type) of the word-of-mouth information.

(Environment Information Text Weighting)

In the case of the word-of-mouth information of text No. tx001, the environment evaluating unit 94 extracts the environment information text “cold” of the text information table. The environment evaluating unit 94 then sets the weighting coefficient at 3 if the temperature in the user information table is 5 degrees Celsius or lower, sets the weighting coefficient at 2 if the temperature is 10 degrees Celsius or lower, and sets the weighting coefficient at 1 in other cases, for example. The weighting coefficient determined in this manner is stored into the weighting information table in FIG. 11 (the third row in FIG. 11). As the environment evaluating unit 94 determines the weighting coefficient, the realistic sensation the user felt when creating the word-of-mouth information can be taken into consideration in determining the weighting coefficient.

Alternatively, the environment evaluating unit 94 may set the weighting coefficient at 2 if there is an accompanying image, and set the weighting coefficient at 1 if there are no accompanying images. Also, in a case where the environment evaluating unit 94 extracts the environment information text “hot”, the weighting coefficient may be set at 3 if the temperature exceeds 35 degrees Celsius, the weighting coefficient may be set at 2 if the temperature is 30 degrees Celsius or higher but lower than 35 degrees Celsius, and the weighting coefficient may be set at 1 in other cases. That is, the criteria for determining the weighting coefficient should be determined beforehand based on whether the text indicates coldness or hotness. Also, the environment evaluating unit 94 may determine the weighting coefficient by taking into account a result of detection conducted by the outfit detecting unit 32. Specifically, in a case where an environment information text such as “cold” or “chilly” is extracted, the weighting coefficient may be set at a high level if the user is heavily dressed. In a case where an environment information text such as “hot” is extracted, the weighting coefficient may be set at a high level if the user is lightly dressed.

(Weighting in Other Cases)

Weighting can also be performed based on the facial expression, the biological information, the outfit, or the like of the user at the time of creation of a text.

For example, the emotion evaluating unit 95 may determine a weighting coefficient in accordance with the facial expression of the user analyzed by the image analyzing unit 30 based on an image captured by the built-in camera 21 at the time of creation of the text (see the fourth row in FIG. 11). In this case, the emotion evaluating unit 95 can set the weighting coefficient at a high level when the facial expression of the user clearly shows a feeling like a sliming face or an angry face.

Also, the emotion evaluating unit 95 may determine the weighting coefficient based on the emotion or excitation of the user detected from the biological information of the user at the time of creation of the text, for example (see the fifth row in FIG. 11). For example, in a case where three of the outputs of the four components, which are the image analyzing unit 30, the biological sensor 23, the microphone 24, and the pressure sensor 26, differ from regular outputs thereof (where the expression detecting unit 31 of the image analyzing unit 30 detects a smile of the user, the biological sensor 23 detects excitation of the user, and the microphone 24 inputs voice of the user (talking to himself/herself), for example), the emotion evaluating unit 95 sets the weighting coefficient at 3. In a case where two of the outputs of the four components differ from the regular outputs thereof, the emotion evaluating unit 95 sets the weighting coefficient at 2. In other cases, the emotion evaluating unit 95 sets the weighting coefficient at 1. As user-specific information such as biological information is preferably determined in the mobile terminal 10, the value in the biological information field in the user information table may be used as the weighting coefficient. Also, the information extracting unit 90 may determine a weighting coefficient based on the outfit of the user detected by the image analyzing unit 30 from an image captured by the built-in camera 21 at the time of creation of the text (see the seventh row in FIG. 11). For example, the information extracting unit 90 can set the weighting coefficient at a high level in a case where a user who is inputting word-of-mouth information about a purchase of clothes is wearing the clothes.

It should be noted that the tables shown in FIG. 10 and FIGS. 12A and 12B are merely examples. Therefore, the tables can be modified as necessary, or more tables may be added.

Referring back to FIG. 9, step S32 is carried out in the above described manner, and the control unit 110 moves on to step S34. The control unit 110 then associates the word-of-mouth information with the weighting information, and stores those pieces of information into the storage unit 100. In this case, the control unit 110 uses the total value or the average value of the weighting coefficients in the record with one text No. in FIG. 11 as the weighting information to be associated with the word-of-mouth information, for example. In a case where there is an important weighting coefficient among the weighting coefficients, the proportion (the weight) of the important weighting coefficient may be increased in calculating the average value.

In step S36, the control unit 110 determines whether there is more word-of-mouth information to be subjected to weighting. In a case where the result of this determination is affirmative, the control unit 110 returns to step S30. In a case where the result is negative, the control unit 110 ends the process shown in FIG. 9.

In a case where there is a request for viewing of the word-of-mouth information from a mobile terminal or a personal computer being used by another user after the process shown in FIG. 9 is completed, the weighting information associated with the word-of-mouth information or a result of a predetermined calculation using the weighting information can be provided as the credibility of the word-of-mouth information, together with the word-of-mouth information, to the viewer. The credibility may be presented in the form of a score. In this case, “The night view from Mt. Hakodate is beautiful, but the wind blowing from the north is cold” (credibility: 8 out of 10) may be displayed, for example. Alternatively, only word-of-mouth information with a certain level of credibility or higher may be provided to viewers.

As described so far in detail, according to this embodiment, a mobile terminal 10 includes the control unit 50 that accepts a word-of-mouth information input from a user, the sensor unit 20 that acquires the user information related to the word-of-mouth information input with permission of the user, and the communication unit 18 that transmits the word-of-mouth information and the user information. Having this structure, the mobile terminal 10 can transmit the information of the user in the middle of inputting the word-of-mouth information to the server 60, while protecting the user's privacy (private information). Accordingly, the indicator for determining credibility of the word-of-mouth information can be transmitted to the server 60, and the server 60 can determine the credibility of the word-of-mouth information and provide information about the credibility, together with the word-of-mouth information, to other users.

In the mobile terminal 10 of this embodiment, the sensor unit 20 acquires information (an image, biological information, the force applied to the touch panel 14, or the like) to be used to estimate an emotion of the user. With the use of this information, the emotion of the user inputting the word-of-mouth information, or the credibility of the word-of-mouth information, can be estimated. Accordingly, the credibility of the word-of-mouth information can be increased. Specifically, with the use of biological information detected by the biological sensor 23, the credibility of the word-of-mouth information can be made to reflect the excitation or the emotion of the user such as joy, anger, pathos, or humor. With the use of a value detected by the pressure sensor 26, the credibility of the word-of-mouth information can be made to reflect a heightened emotion. Also, with the use of the facial expression of the user shown in an image captured by the built-in camera 21, the credibility of the word-of-mouth information can be made to reflect the emotion of the user. Further, with the use of the outfit of the user shown in an image captured by the built-in camera 21, the credibility of the word-of-mouth information can be made to reflect a result of a comparison between the outfit and the word-of-mouth information. Also, with the use of voice of the user or sound or temperature in the surrounding area, the credibility of the word-of-mouth information can be further increased.

In this embodiment, metadata accompanying image data is detected and transmitted to the server 60 with permission of the user. Accordingly, it is possible to detect and transmit metadata while protecting the user's privacy (private information) such as the place where the user stayed.

In this embodiment, the server 60 includes the information input unit 80 that inputs word-of-mouth information and information of the user in the middle of creating the word-of-mouth information, and the information extracting unit 90 that extracts information related to one information set of the word-of-mouth information and the user information from the other information set of the word-of-mouth information and the user information. With this structure, the server 60 can appropriately determine the credibility of the word-of-mouth information by extracting the information pieces related to each other from the word-of-mouth information and the user information.

In this embodiment, the information extracting unit 90 determines a weighting coefficient in relation to a text included in word-of-mouth information based on extracted information. As a weighting coefficient is determined for a text included in word-of-mouth information, and weighting is performed on the word-of-mouth information based on the determined weighting coefficient, the credibility of the word-of-mouth information can be appropriately evaluated. Also, as the control unit 110 notifies a user who wishes viewing of the credibility of the word-of-mouth information, the user viewing the word-of-mouth information can determine whether to believe the word-of-mouth information based on the credibility.

In this embodiment, the location evaluating unit 92 determines a weighting coefficient by extracting a location as user information and comparing the extracted location with the location information text in the word-of-mouth information. That is, the location evaluating unit 92 makes the weight larger when the difference between the location information text and the location of the input of the word-of-mouth information is smaller. Accordingly, a weighting coefficient can be determined by taking into account the realistic sensation that was felt by the user while he/she was creating the word-of-mouth information.

In this embodiment, when word-of-mouth information is accompanied by an image, the metadata of the image is compared with the word-of-mouth information and/or user information, and weighting is performed on the word-of-mouth information based on a result of the comparison. Accordingly, weighting can be performed by taking into consideration the consistency among the image, the word-of-mouth information, and the user information, and credibility can be appropriately determined.

In this embodiment, in a mobile terminal 10, the control unit 50 accepts an input of word-of-mouth information from a user, and the biological sensor 23 acquires biological information of the user in relation to the input with permission of the user. Accordingly, it is possible to acquire the information for determining the emotion or the like felt by the user during the input of the word-of-mouth information, while protecting the user's privacy (private information).

In the above described embodiment, a viewer may be allowed to transmit information related to sex, age, and size (such as height, weight, and dress size) to the server 60. In this case, the control unit 110 of the server 60 can preferentially provide the viewer with word-of-mouth information created by a user who is similar to the viewer. For example, the control unit 110 stores word-of-mouth information including information about sizes in clothes and the like (heights, weights, and dress sizes), together with weighting coefficients, into the storage unit 100 in advance, and word-of-mouth information including similar information about sex, age, and size in clothes (such as height, weight, and dress size) to the sex, the age, and the size in clothes of the viewer is provided, together with credibility information. In this manner, a person who wishes viewing can preferentially acquire word-of-mouth information created by a user who is similar to himself/herself.

In the above described embodiment, the control unit 110 determines credibility of word-of-mouth information based on weighting coefficients determined by the location evaluating unit 92, the time evaluating unit 93, the environment evaluating unit 94, and the emotion evaluating unit 95. However, the present invention is not limited to that. For example, in the information extracting unit 90, credibility of word-of-mouth information may be determined with the use of weighting coefficients determined by the respective units 92 through 95, and be output to the control unit 110.

In the above described embodiment, word-of-mouth information is classified into the two types: the experience type and the purchase type. However, the present invention is not limited to them. Other types may be used, and tables such as a location information comparison table and a time information comparison table may be prepared for each type.

It should be noted that the image data table (FIG. 4), the user information table (FIG. 5), and the text information table (FIG. 7), which are used in the above described embodiment, are merely examples. All the tables may be integrated into one table, or the image data table (FIG. 4) and the user information table (FIG. 5) may be integrated into one table. Also, some of the fields in each table may be omitted, or more fields may be added.

In the above described embodiment, each mobile terminal 10 includes the image analyzing unit 30. However, the present invention is not limited to that, and the image analyzing unit 30 may be included in the server 60. In this case, detection of a facial expression in an image captured by the built-in camera 21, detection of an outfit, and detection of metadata (EXIF data) are conducted in the server 60. In this case, a facial expression DB and an outfit DB can be stored in the storage unit 100 of the server 60, and therefore, there is no need to store the facial expression DB and the outfit DB in the storage unit 40 of each mobile terminal 10. As a result, the storage area of the storage unit 40 can be efficiently used, and management such as uploading of the facial expression DB and the outfit DB becomes easier.

In the above described embodiment, the process related to weighting is performed by the server 60, but may be performed by each mobile terminal 10, instead.

In the above described embodiment, the terminal that creates word-of-mouth information is a smartphone. However, the present invention is not limited to such a case. For example, the present invention can also be applied to creation of word-of-mouth information with the use of a personal computer. In this case, it is possible to use a user-image capturing camera (such as a USB camera) provided in the vicinity of the display of the personal computer, instead of the built-in camera 21. Further, in a case where a personal computer is used, the pressure sensor 26 is set in the keyboard of the personal computer.

The above described exemplary embodiment is a preferred embodiment of the present invention. However, the present invention is not limited to that, and other embodiments, variations, and modifications may be made without departing from the scope of the present invention. The disclosures of the publications cited in the above description are incorporated herein by reference.

1. An electronic device comprising:
an input unit configured to input a text from a user;
an information acquiring unit configured to acquire information relating to the user in association with the text when allowed to acquire the information by the user; and
a transmitting unit configured to transmit the text and the information of the user.

2. The electronic device according to claim 1, wherein the information acquiring unit acquires information relating to an emotion of the user.

3. The electronic device according to claim 1, wherein the information acquiring unit includes a biological sensor configured to acquire biological information of the user.

4. The electronic device according to claim 1, wherein the information acquiring unit includes a force sensor configured to detect a force related to an operation of the input unit by the user.

5. The electronic device according to claim 1, wherein the information acquiring unit includes an imaging unit configured to capture an image of the user in relation to an operation of the input unit by the user.

6. The electronic device according to claim 1, wherein the information acquiring unit includes an environment sensor configured to acquire information relating to an environment of the user in association with an operation of the input unit by the user.

7. The electronic device according to claim 1, wherein the transmitting unit transmits image data together with the text and the information of the user.

8. The electronic device according to claim 7, wherein the transmitting unit transmits metadata accompanying the image data when allowed to transmit the metadata by the user.

9. The electronic device according to claim 7, wherein the transmitting unit does not transmit metadata accompanying the image data when not allowed to transmit the metadata by the user.

10. The electronic device according to claim 8, further comprising a detecting unit configured to detect the metadata.

11. The electronic device according to claim 10, wherein the detecting unit conducts the detection when allowed to detect the metadata by the user.

12. The electronic device according to claim 1, further comprising a weighting unit configured to extract text information corresponding to the information of the user from the text, and perform weighting on the text based on a result of a comparison between the information of the user and the corresponding text information.

13. An electronic device comprising:
an input unit configured to receive an input from a user; and
a biological sensor configured to sense biological information of the user when allowed to sense the biological information by the user.

14. An electronic device comprising:
an input unit configured to input a text and information of a user when the user operated the input unit; and
an extracting unit configured to extract information related to one of the text and the information of the user from the other one of the text and the information of the user.

15. The electronic device according to claim 14, further comprising a weighting unit configured to perform weighting on the text based on the information extracted by the extracting unit.

16. The electronic device according to claim 15, wherein the weighting unit performs the weighting on the text based on a result of a comparison between the information of the user and the text corresponding to the information of the user.

17. The electronic device according to claim 15, further comprising a notifying unit configured to make a notification concerning the text based on a result of the weighting.

18. The electronic device according to claim 14, wherein the extracting unit extracts information relating to an emotion of the user.

19. The electronic device according to claim 14, wherein the extracting unit extracts information relating to an environment of the user.

20. The electronic device according to claim 14, wherein the extracting unit extracts information relating to at least one of a location and a date.

21. The electronic device according to claim 14, further comprising:
an image input unit configured to input image data and metadata accompanying the image data; and
a comparing unit configured to compare at least one of the text and the information of the user with the metadata.

22. The electronic device according to claim 21, further comprising a weighting unit configured to perform weighting on the text based on a result of the comparison performed by the comparing unit.

23. The electronic device according to claim 14, further comprising:
an acquiring unit configured to acquire information of a person wishing to view the text;
a detecting unit configured to detect information of the user, the information of the user being similar to the information of the person wishing to view the text; and
a providing unit configured to provide the text based on the information of the user detected by the detecting unit.

24. The electronic device according to claim 15, the weighting unit performs the weighting in accordance with a difference between a text information of a location and an operation place of the input unit when the text includes the location.

25. The electronic device according to claim 15, wherein the weighting unit performs the weighting in accordance with a difference between a text information of a date and an operation date of the input unit when the text includes the date.

26. The electronic device according to claim 15, wherein the weighting unit performs the weighting in accordance with a difference between a text information of a date and a date of acquisition of an object when the text includes the evaluation of the object.

27. The electronic device according to claim 24, wherein further comprising a judgement unit that judges reliability of the text in accordance with a score of the weight.
